(19) United States
(12) Patent Application Publication
(10) Pub. No.: US 2013/0263117 A1
(43) Pub. Date: Oct. 3, 2013

(54) ALLOCATING RESOURCES TO VIRTUAL MACHINES VIA A WEIGHTED COST RATIO

(71) Applicants: Rafal P. Konik, Oronoco, MN (US); Roger A. Mittelstadt, Byron, MN (US); Brian R. Muras, Rochester, MN (US); Mark W. Theuer, Rochester, MN (US)

(72) Inventors: Rafal P. Konik, Oronoco, MN (US); Roger A. Mittelstadt, Byron, MN (US); Brian R. Muras, Rochester, MN (US); Mark W. Theuer, Rochester, MN (US)

(73) Assignee: International Business Machines Corporation, Armonk, NY (US)

(21) Appl. No.: 13/432,815

(22) Filed: Mar. 28, 2012

(51) Int. Cl. G06F 9/50; G06F 9/455

(52) U.S. Cl. 718/1

(57) ABSTRACT

In an embodiment, a plurality of estimates of costs of executing a plurality of respective queries is received from a plurality of respective virtual machines using a plurality of respective estimated resources allocated to the plurality of respective virtual machines. A selected virtual machine of the plurality of respective virtual machines is selected with a lowest weighted cost ratio, as compared to all other of the plurality of respective virtual machines. A source virtual machine is found with a lowest current resource usage. An amount of a resource to deallocate from the source virtual machine is calculated, which further comprises estimating the amount of the resource to deallocate that does not raise the lowest current resource usage over a maximum resource threshold. The amount of the resource from the source virtual machine is deallocated. The amount of the resource is allocated to the selected virtual machine.

### FIELD

An embodiment of the invention generally relates to database management systems that process queries in virtual machines with execution plans and more particularly to allocating resources to virtual machines that process queries.

### BACKGROUND

Computer systems typically comprise a combination of computer programs and hardware, such as semiconductors, transistors, chips, circuit boards, storage devices, and processors. The computer programs are stored in the storage devices and are executed by the processors. Fundamentally, computer systems are used for the storage, manipulation, and analysis of data.

One mechanism for managing data is called a database management system (DBMS) or simply a database. Many different types of databases are known, but the most common is usually called a relational database, which organizes data in tables that have rows, which represent individual entries, tuples, or records in the database, and columns, fields, or attributes, which define what is stored in each entry, tuple, or record. Each table has a unique name within the database and each column has a unique name within the particular table. The database also has one or more indexes, which are data structures that inform the DBMS of the location of a certain row in a table given an indexed column value, analogous to a book index informing the reader of the page on which a given word appears.

The most common way to retrieve data from a database is through statements called database queries, which may originate from user interfaces, application programs, or remote computer systems, such as clients or peers. A query is an expression evaluated by the DBMS, in order to retrieve data from the database that satisfies or meets the criteria or conditions specified in the query. Although the query requires the return of a particular data set in response, the method of query execution is typically not specified by the query. Thus, after the DBMS receives a query, the DBMS interprets the query and determines what internal steps are necessary to satisfy the query. These internal steps may comprise an identification of the table or tables specified in the query, the row or rows selected in the query, and other information such as whether to use an existing index, whether to build a temporary index, whether to use a temporary file to execute a sort, and/or the order in which the tables are to be joined together to satisfy the query. When taken together, these internal steps are referred to as an execution plan. The DBMS often saves the execution plan and reuses it when the user or requesting program repeats the query, which is a common occurrence, instead of undergoing the time-consuming process of recreating the execution plan.

The operations of the DBMS may be performed as a part of a virtual machine that executes on a computer. The execution of the virtual machine may be started and stopped on a computer system, the virtual machine may be moved between computer systems that belong to a cloud of computer systems, and resources within the cloud of computer systems maybe allocated and deallocated to the virtual machines.

### SUMMARY

A method, computer-readable storage medium, and computer system are provided. In an embodiment, a plurality of estimates of costs of executing a plurality of respective queries is received from a plurality of respective virtual machines using a plurality of respective estimated resources allocated to the plurality of respective virtual machines. A selected virtual machine of the plurality of respective virtual machines is selected with a lowest weighted cost ratio, as compared to all other of the plurality of respective virtual machines. A source virtual machine is found from among the plurality of respective virtual machines with a lowest current resource usage. An amount of a resource to deallocate from the source virtual machine is calculated, which further comprises estimating the amount of the resource to deallocate that does not raise the lowest current resource usage over a maximum resource threshold. The amount of the resource from the source virtual machine is deallocated. The amount of the resource is allocated to the selected virtual machine.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a cloud of computer systems connected via a network, according to an embodiment of the invention.

FIG. 3 depicts a block diagram of an example database management system, according to an embodiment of the invention.

FIG. 4 depicts a block diagram of an example data structure for cost data for a virtual machine, according to an embodiment of the invention.

FIG. 5 depicts a block diagram of an example data structure for cost data for another virtual machine, according to an embodiment of the invention.

FIG. 6 depicts a block diagram of an example data structure for cost data for another virtual machine, according to an embodiment of the invention.

FIG. 7 depicts a block diagram of an example data structure for amalgamated cost data from multiple virtual machines, according to an embodiment of the invention.

FIG. 8 depicts a flowchart of example processing for a query, according to an embodiment of the invention.

FIG. 9 depicts a flowchart of example processing for a cloud resource manager, according to an embodiment of the invention.

FIG. 10 depicts a flowchart of example processing for attempting to allocate resources to a virtual machine, according to an embodiment of the invention.

FIG. 11 depicts a flowchart of example processing for selecting a virtual machine from which to move allocated resources, according to an embodiment of the invention.

It is to be noted, however, that the appended drawings illustrate only example embodiments of the invention, and are therefore not considered a limitation of the scope of other embodiments of the invention.

### DETAILED DESCRIPTION

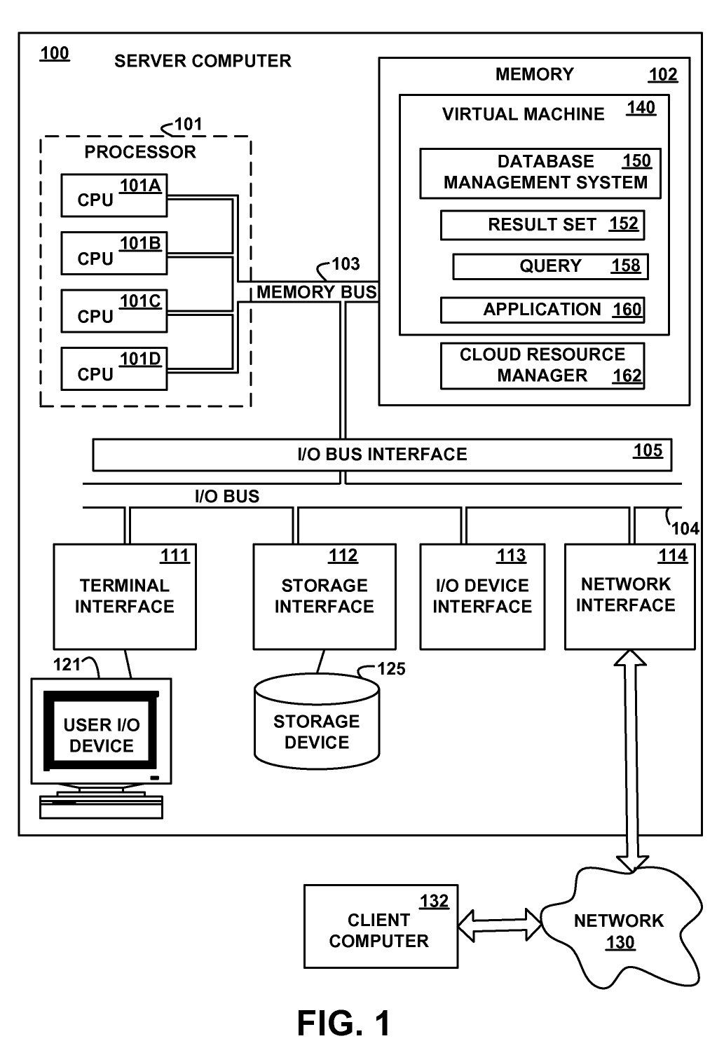

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The terms “server” and “client” are used herein for convenience only, and in various embodiments a computer system that operates as a client computer in one environment may operate as a server computer in another environment, and vice versa. The mechanisms and apparatus of embodiments of the present invention apply equally to any appropriate computing system.

The major components of the computer system 100 comprise one or more processors 101, a memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the memory 102 and may comprise one or more levels of on-board cache.

In an embodiment, the memory 102 may comprise a random-access semiconductor memory, storage device, or storage medium (either volatile or non-volatile) for storing or encoding data and programs. In another embodiment, the memory 102 represents the entire virtual memory of the computer system 100, and may also include the virtual memory of other computer systems coupled to the computer system 100 or connected via the network 130. The memory 102 is conceptually a single monolithic entity, but in other embodiments the memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 stores or encodes a virtual machine 140 and a cloud resource manager 162. In various embodiments, the cloud resource manager 162 may be a part of the virtual machine 140, different from the virtual machine 140, stored and executed on the same computer as the virtual machine 140, or stored and executed on a different computer as the virtual machine 140. The virtual machine 140 comprises a database management system 150, a result set 152, a query 158, and an application 160. In an embodiment, the virtual machine 140 is a program implementation of a physical machine that executes programs. In various embodiments, the memory 102 may store any number of virtual machines comprising the same or different database management systems, result sets, queries, and/or applications. Virtual machines allow the sharing of physical machine resources between different virtual machines, each running its own operating system (typically called guest operating systems), which may be the same or different from each other. Virtual machines may allow multiple operating system environments to co-exist on the same computer, in isolation from each other. Virtual machines may provide an instruction set architecture that is somewhat different from that of the underlying physical machine or processor 101.

In an embodiment, the virtual machine 140 is implemented as a logical partition in a logically-partitioned computer. In another embodiment, the virtual machine 140 executes within a logical partition in a logically-partitioned computer, and the virtual machine 140 may move between logical partitions within the same logically-partitioned computer or different logically partitioned computers. Each logical partition in a logically-partitioned computer may comprise and utilize an OS (operating system), which controls the primary operations of the logical partition in the same manner as the operating system of a non-partitioned computer. Some or all of the operating systems may be the same or different from each other. Any number of logical partitions may be supported, and the number of the logical partitions resident at any time in the computer 100 may change dynamically as partitions are added or removed from the computer 100. A hypervisor may add, remove, start, and/or shutdown logical partitions and may allocate resources to and deallocate resources from the logical partitions. In an embodiment, the cloud resource manager 162 acts as the hypervisor. In another embodiment, the cloud resource manager 162 is separate from the hypervisor.

Each virtual machine 140 or logical partition comprises instructions that execute on the processor 101 in a separate, or independent, memory space, and thus each logical partition acts much the same as an independent, non-partitioned computer from the perspective of each application 160 that executes in each such logical partition. As such, the applications 160 typically do not require any special configuration for use in a partitioned environment.

Given the nature of logical partitions as separate virtual computers, it may be desirable to support inter-partition communication to permit the logical partitions to communicate with one another as if the logical partitions were on separate physical machines. As such, in an embodiment an unillustrated virtual local area network (LAN) adapter associated with a hypervisor permits the virtual machines 140 or the logical partitions to communicate with one another via a networking protocol. In another embodiment, the virtual network adapter may bridge to a physical adapter, such as the network adapter 114. Other manners of supporting communication between logical partitions may also be supported consistent with embodiments of the invention.

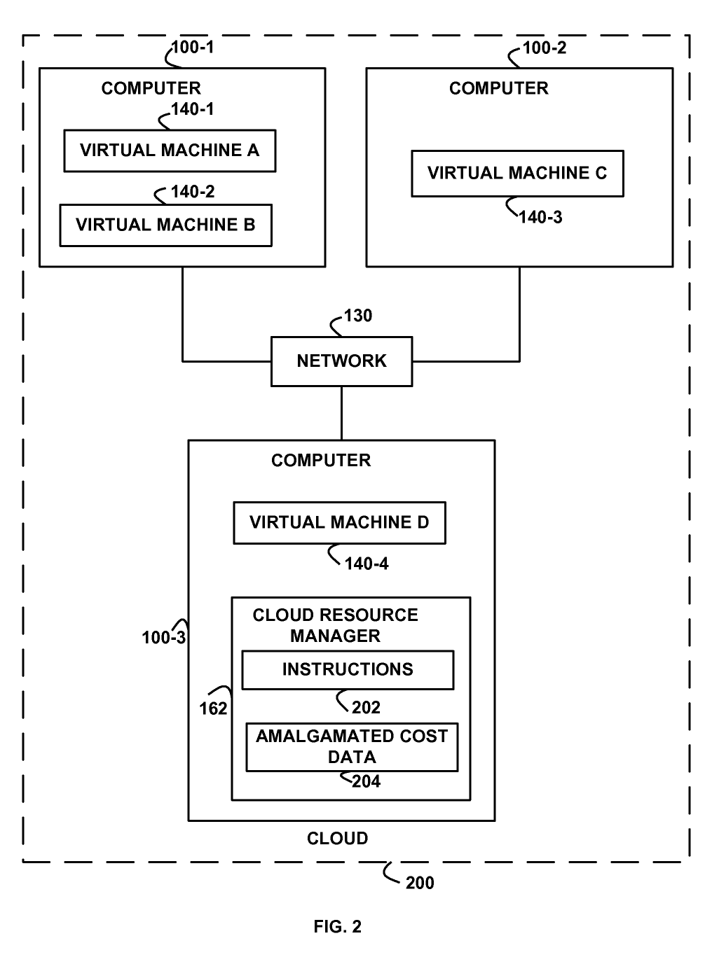

In an embodiment, the virtual machine 140, the DBMS 150, the application 160, and/or the cloud resource manager 162 comprise instructions or statements that execute on the processor 101 or instructions or statements that are interpreted by instructions or statements that execute on the processor 101, to carry out the functions as further described below with reference to FIGS. 2, 3, 4, 5, 6, 7, 8, 9, 10, and 11. In another embodiment, the virtual machine 140, the DBMS 150, the application 160, and/or the cloud resource manager 162 are implemented in hardware via semiconductor devices, chips, logical gates, circuits, circuit cards, and/or other physical hardware devices in lieu of, or in addition to, a processor-based system. In an embodiment, the virtual machine 140, the DBMS 150, the application 160, and/or the cloud resource manager 162 comprise data in addition to instructions or statements. In various embodiments, the application 160 is a user application, a third-party application, an operating system, or any portion, multiple, or combination thereof.

The memory bus 103 provides a data communication path for transferring data among the processor 101, the memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the memory 102, or any portion thereof, may be stored to and retrieved from the storage device 125, as needed. The I/O device interface 113 provides an interface to any of various other input/output devices or devices of other types, such as printers or fax machines. The network adapter 114 provides one or more communications paths from the computer system 100 to other digital devices and computer systems 132; such paths may comprise, e.g., one or more networks 130.

Although the memory bus 103 is shown in FIG. 1 as a relatively simple, single bus structure providing a direct communication path among the processors 101, the memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and the computer system 132. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

The computer system 132 may comprise some or all of the hardware and/or computer program elements of the computer system 100. In an embodiment, the application 160 may be stored in a storage device at the client computer 132, may execute on a processor at the client computer 132, and may send queries 158 to and receive result sets 152 from the virtual machine 140 via the network 130.

FIG. 1 is intended to depict the representative major components of the computer system 100, the network 130, and the computer system 132. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a cloud 200 that comprises the computer systems 100-1, 100-2, and 100-3 connected via the network 130, according to an embodiment of the invention. The computer systems 100-1, 100-2, and 100-3 are examples of, and are generically referred to by, the computer system 100 (FIG. 1). Referring again to FIG. 2, the computer systems 100-1, 100-2, and 100-3 comprise respective virtual machines 140-1, 140-2, 140-3, and 140-4, which are examples of, and are generically referred to by, the virtual machine 140 (FIG. 1). Referring again to FIG. 2, in various embodiments, the virtual machines 140-1, 140-2, 140-3, and 140-4 may be the same or different from each other. Although the virtual machines 140-1, 140-2, 140-3, and 140-4 are illustrated as being implemented on different computers 100-1, 100-2, and 100-3, in other embodiments, some or all of the virtual machines 140-1, 140-2, 140-3, and 140-4 may execute on the same computer. The virtual machines 140-1, 140-2, 140-3, and 140-4 may be started, powered up, stopped, shutdown, powered down, and moved or copied between the different memory of the computer systems 100-1, 100-2, and 100-3.

The computer 100-3 further comprises a cloud resource manager 162, which comprises instructions 202 stored in a storage device and executed by the computer 100-3 and amalgamated cost data 204 stored in a storage device of the computer 100-3. In various embodiments, each virtual machine 140-1, 140-2, 140-3, and 140-4 may have its own cloud resource manager 162, each computer 100-1, 100-2, and 100-3 may have its own cloud resource manager 162, or the cloud 200 may have one cloud resource manager 162 for all computers and all virtual machines 140-1, 140-2, 140-3, and 140-4 in the cloud 200. In various embodiments, the cloud resource manager 162 may allocate resources to and deallocate resources from the virtual machines 140-1, 140-2, 140-3, and 140-4, or only those virtual machines that execute at the same computer as the cloud resource manager 162.

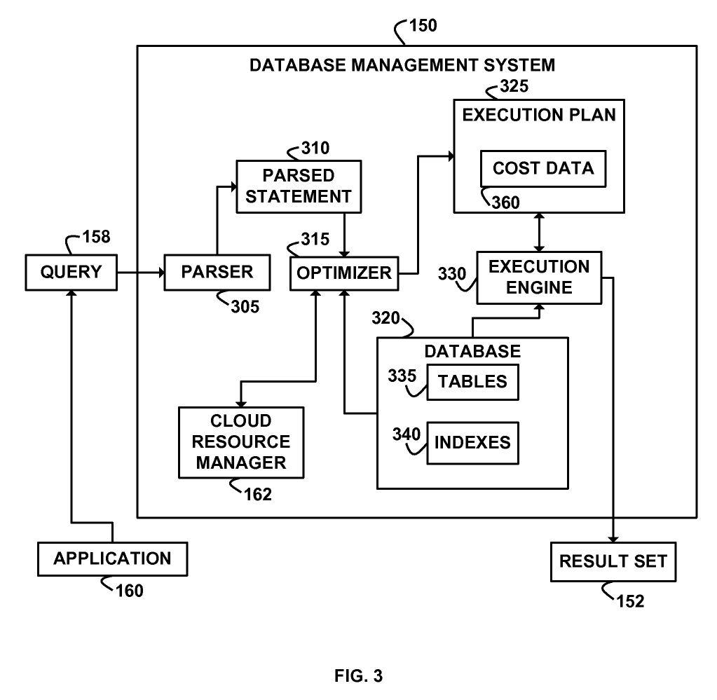

FIG. 3 depicts a block diagram of an example database management system 150, according to an embodiment of the invention. The DBMS 150 comprises a cloud resource manager 162, a parser 305, a parsed statement 310, an optimizer 315, a database 320, an execution plan 325, and an execution engine 330. The database 320 comprises tables 335 and one or more indexes 340. The tables 335 organize data in rows, which represent individual entries, tuples, or records and columns, fields, or attributes, which define what is stored in each row, entry, tuple, or record. Each table 335 has a unique name within the database 320 and each column has a unique name within the particular table 335. The indexes 340 are data structures that inform the DBMS 150 of the location of a certain row in a table 335 in response to the indexes 340 receiving an indexed column value.

The parser 305 in the DBMS 150 receives the query 158 from the application 160. The query 158 requests that the DBMS 150 search for or find a row or combination of rows of data and store the data from those found rows into the result set 152 that meet or satisfy the criteria, keys, and or values specified by the query 158. In an embodiment, the application 160 sends the same query 158 multiple times to the DBMS 150, which may or may not result in a different result set 152, depending on whether the data in the DBMS 150 has changed between occurrences of the query 158. The parser 305 generates a parsed statement 310 from the query 158, which the parser 305 sends to the optimizer 315. The optimizer 315 performs query optimization on the parsed statement 310. As a result of query optimization, the optimizer 315 generates one or more execution plans 325, using data such as resource availability, platform capabilities, query content information, etc., that is stored in the database 320. Once generated, the optimizer 315 sends the execution plan 325 to the execution engine 330, which executes the query 158 using the execution plan 325 and the indexes 340, in order to find and retrieve the data in the database tables 335 in the database 320 that satisfies the criteria of the query 158. The execution engine 330 stores the resultant data that satisfies the criteria specified by the query 158 into the result set 152, which is returned to the application 160 as a response to the query 158. In an embodiment, the DBMS 150 stores various thresholds and cost data 360 into the execution plan 325. The DBMS 150 may receive the various thresholds from the application 160, from a user, or from a database administrator, or the thresholds may be set by a designer of the optimizer 315.

The execution plan 325 comprises cost data 360, which describes the resources currently or estimated to be allocated to the virtual machine 140 in which the DBMS 150 executes and the impact of those resources on the cost or time to execute the execution plan 325. The execution plan 325 may also comprise a tree graph, representing the join operations that implement the query 158 when executed by the execution engine 330. Although the cost data 360 is illustrated as being stored within the execution plan 325, in other embodiments, the cost data 360 is stored externally to the execution plan 325 or externally to the database management system 150.

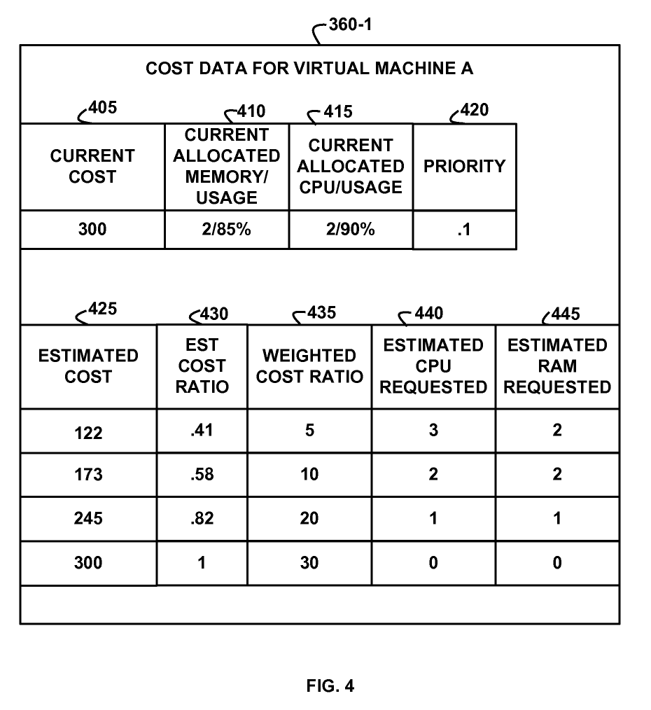

FIG. 4 depicts a block diagram of an example data structure for cost data 360-1 for a virtual machine A, according to an embodiment of the invention. The cost data 360-1 is an example of, and is generically referred to by, the cost data 360 (FIG. 3). The cost data 360-1 represents the various estimated and actual current costs of executing an execution plan 325 for a query at the virtual machine A 140-1. In an embodiment, the virtual machine A 140-1 stores the cost data 360-1 in a storage device at the computer 100-1 and sends the cost data 360-1, or selected portions thereof, to the cloud resource manager 162, which stores the cost data 360-1, or selected portions of the cost data 360-1, into the amalgamated cost data 204.

The cost data 360-1 comprises a current cost field 405, a current allocated memory/usage field 410, a current allocated CPU/usage field 415, and a priority field 420. The current cost field 405 specifies the most recent or average actual cost or run time (specified in time, such as seconds, minutes, hours, days, or any portion, multiple or combination thereof) of executing the execution plan 325 at the virtual machine 140-1. If the execution plan 325 has not yet been executed or historical data does not exist, then the current cost field 405 specifies an initial estimated cost. The current allocated memory/usage 410 field specifies an amount of memory (in units of megabytes, gigabytes or any other appropriate units) that is currently allocated to the virtual machine A 140-1 and the percentage or amount of the memory allocated to the virtual machine A 140-1 that the virtual machine A 140-1 uses in executing the query represented by the execution plan 325 in the virtual machine A 140-1. The current allocated CPU/usage field 415 specifies an amount of a CPU (in units of numbers of CPUs, time slices of CPUs, percentages of CPUs, or any other appropriate units) that is currently allocated to the virtual machine A 140-1 and the percentage or amount of the CPUs allocated to the virtual machine A 140-1 that the virtual machine A 140-1 uses in executing the query represented by the execution plan 325 in the virtual machine A 140-1. The priority 420 specifies the priority or importance of the virtual machine A 140-1 that stores the cost data 360-1, as compared to, or relative to, all other virtual machines. In various embodiments, the priority 420, for all virtual machines 140, may be scaled, so that, e.g., all priorities are between zero and one, zero and hundred, or within any other appropriate range of values. In various embodiments, the optimizer 315 calculates the cost data 360-1 per a query, per a workload, or per a group of queries, such as all queries sent by the same application or job, or all queries in a batch or set of queries.

The cost data 360-1 further comprises entries, each entry comprising an estimated cost field 425, an estimated (est) cost ratio field 430, a weighted cost ratio field 435, an estimated CPU requested field 440, and an estimated RAM requested field 445.

The estimated cost 425, in an entry, is the cost (e.g., the estimated time), that the optimizer 315 estimates executing the execution plan 325 for the query will take using the current allocated resources (the current allocated memory 410 and the current allocated CPU 415) plus the estimated amount of resources requested (the estimated CPU requested 440 and the estimated RAM requested 445). The optimizer 315 calculates the estimated costs 425 (in the various entries) to execute the query using a variety of amounts (in various entries) of CPU and memory, e.g., a larger amount of CPU and memory than amounts currently allocated to the virtual machine A 140-1, a larger amount of CPU and the same amount of memory as currently allocated to the virtual machine A 140-1, a larger amount of memory and the same amount of CPU as currently allocated to the virtual machine A 140-1, less memory and the same amount of CPU as currently allocated to the virtual machine A 140-1, a smaller amount of CPU and the same amount of memory as currently allocated to the virtual machine A 140-1, and less memory and a smaller amount of CPU as currently allocated to the virtual machine A 140-1. In various embodiments, the optimizer 315 calculates the estimated costs 425 using determinations of whether the current execution of the query using current amounts of resources is CPU constrained, memory constrained, both, or neither, by analyzing the impact of increased or decreased parallelism of execution if more or less CPU power is available, and by analyzing the impact on execution of the use of more or fewer indexes if more or less amounts of memory is allocated. In various embodiments, the optimizer 315 calculates the estimated costs 425 by calculating the number of values in each column referenced by the query, by calculating the amount of CPU time and/or memory needed to process each value, and by computing the product of the number of values and the amount of CPU time and/memory needed per value, or by any other appropriate technique. The optimizer 315 calculates the estimated cost ratio 430 of the estimated cost to the current cost, for each estimated cost in each entry by calculating the respective estimated cost 425 divided by the current cost 405.

The optimizer 315 calculates the weighted cost ratio 435, in each entry, to be the priority 420 multiplied by the estimated cost 425, in the same entry, multiplied by the estimated cost ratio 430, in the same entry. Thus, the weighted cost ratio 435=(the priority 420)*(the estimated cost 425)*(the estimated cost 425/the current cost 405), which implies that the weighted cost ratio 435=(the priority 420)*(the estimated cost 425)²/(the current cost 405).

Although FIG. 4 illustrates data regarding the resources of memory and CPU, in other embodiments, resources may comprise bandwidth of the network interface 114 or the network 130, portions or multiples of the storage device 125, or any other resource of the computer 100 capable of being allocated (either exclusively or shared with other virtual machines) to the virtual machine A 140-1.

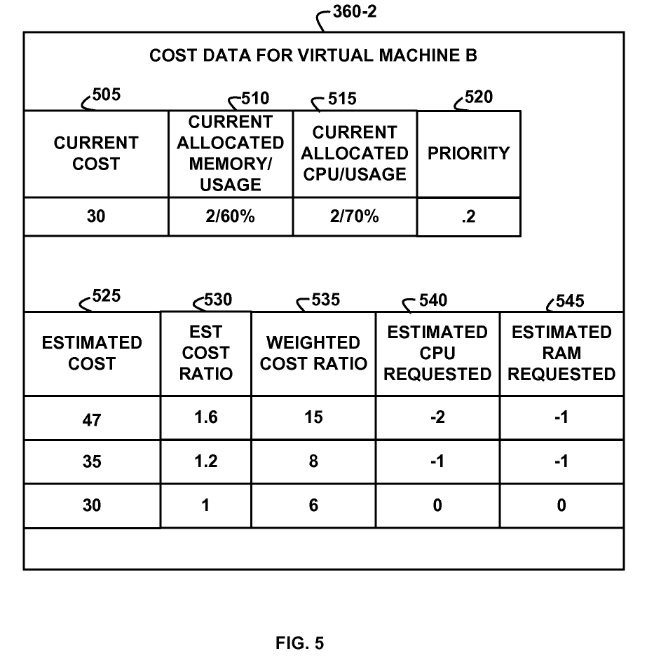

FIG. 5 depicts a block diagram of an example data structure for cost data 360-2 for a virtual machine B 140-2, according to an embodiment of the invention. The cost data 360-2 is an example of, and is generically referred to by, the cost data 360 (FIG. 3). The cost data 360-2 represents the various estimated and actual current costs of executing an execution plan 325 for a query at the virtual machine B 140-2. In an embodiment, the virtual machine B 140-2 stores the cost data 360-2 in a storage device at the computer 100-1 and sends the cost data 360-2, or selected portions thereof, to the cloud resource manager 162, which stores the cost data 360-2, or selected portions of the cost data 360-2, into the amalgamated cost data 204.

The cost data 360-2 comprises a current cost field 505, a current allocated memory/usage field 510, a current allocated CPU/usage field 515, and a priority field 520. The current cost field 505 specifies the most recent or average actual cost or run time (specified in time, such as seconds, minutes, hours, days, or any portion, multiple or combination thereof) of executing the execution plan 325 at the virtual machine 140-2. If the execution plan 325 has not yet been executed or historical data does not exist, then the current cost field 505 specifies an initial estimated cost. The current allocated memory/usage 510 field specifies an amount of memory (in units of megabytes, gigabytes or any other appropriate units) that is currently allocated to the virtual machine B 140-2 and the percentage or amount of the memory allocated to the virtual machine B 140-2 that the virtual machine B 140-2 uses in executing the query represented by the execution plan 325 in the virtual machine B 140-2. The current allocated CPU/usage field 515 specifies an amount of a CPU (in units of numbers of CPUs, time slices of CPUs, percentages of CPUs, or any other appropriate units) that is currently allocated to the virtual machine B 140-2 and the percentage or amount of the CPUs allocated to the virtual machine B 140-2 that the virtual machine B 140-2 uses in executing the query represented by the execution plan 325 in the virtual machine B 140-2. The priority 520 specifies the priority or importance of the virtual machine B 140-2 that stores the cost data 360-2, as compared to, or relative to, all other virtual machines. In various embodiments, the priority 520, for all virtual machines 140, may be scaled, so that, e.g., all priorities are between zero and one, zero and hundred, or within any other appropriate range of values. In various embodiments, the optimizer 315 calculates the cost data 360-2 per a query, per a workload, or per a group of queries, such as all queries sent by the same application or job, or all queries in a batch or set of queries.

The cost data 360-2 further comprises entries, each entry comprising an estimated cost field 525, an estimated (est) cost ratio field 530, a weighted cost ratio field 535, an estimated CPU requested field 540, and an estimated RAM requested field 545.

The estimated cost 525, in an entry, is the cost (e.g., the estimated time), that the optimizer 315 estimates executing the execution plan 325 for the query will take using the current allocated resources (the current allocated memory 510 and the current allocated CPU 515) plus the estimated amount of resources requested (the estimated CPU requested 540 and the estimated RAM requested 545). The optimizer 315 calculates the estimated costs 525 (in the various entries) to execute the query using a variety of amounts (in various entries) of CPU and memory, e.g., a larger amount of CPU and memory than amounts currently allocated to the virtual machine B 140-2, a larger amount of CPU and the same amount of memory as currently allocated to the virtual machine B 140-2, a larger amount of memory and the same amount of CPU as currently allocated to the virtual machine B 140-2, less memory and the same amount of CPU as currently allocated to the virtual machine B 140-2, a smaller amount of CPU and the same amount of memory as currently allocated to the virtual machine B 140-2, and less memory and a smaller amount of CPU as currently allocated to the virtual machine B 140-2. The optimizer 315 calculates the estimated cost ratio 530 of the estimated cost to the current cost, for each estimated cost in each entry by calculating the respective estimated cost 525 divided by the current cost 505.

The optimizer 315 calculates the weighted cost ratio 535, in each entry, to be the priority 520 multiplied by the estimated cost 525, in the same entry, multiplied by the estimated cost ratio 530, in the same entry. Thus, the weighted cost ratio 535=(the priority 520)*(the estimated cost 525)*(the estimated cost 525/the current cost 505), which implies that the weighted cost ratio 535=(the priority 520)*(the estimated cost 525)²/(the current cost 505).

Although FIG. 5 illustrates data regarding the resources of memory and CPU, in other embodiments, resources may comprise bandwidth of the network interface 114 or the network 130, portions or multiples of the storage device 125, or any other resource of the computer 100 capable of being allocated (either exclusively or shared with other virtual machines 140) to the virtual machine B 140-2.

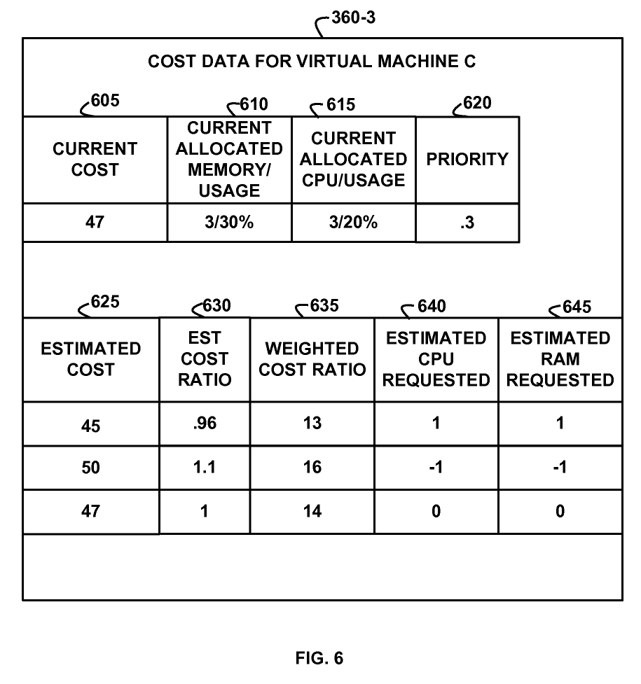

FIG. 6 depicts a block diagram of an example data structure for cost data 360-3 for a virtual machine C, according to an embodiment of the invention. The cost data 360-3 is an example of, and is generically referred to by, the cost data 360 (FIG. 3). The cost data 360-3 represents the various estimated and actual current costs of executing an execution plan 325 for a query at the virtual machine C 140-3. In an embodiment, the virtual machine C 140-3 stores the cost data 360-3 in a storage device at the computer 100-2 and sends the cost data 360-3, or selected portions thereof, to the cloud resource manager 162, which stores the cost data 360-3, or selected portions of the cost data 360-3, into the amalgamated cost data 204.

The cost data 360-3 comprises a current cost field 605, a current allocated memory/usage field 610, a current allocated CPU/usage field 615, and a priority field 620. The current cost field 605 specifies the most recent or average actual cost or run time (specified in time, such as seconds, minutes, hours, days, or any portion, multiple or combination thereof) of executing the execution plan 325 at the virtual machine C 140-3. If the execution plan 325 has not yet been executed or historical data does not exist, then the current cost field 605 specifies an initial estimated cost. The current allocated memory/usage 610 field specifies an amount of memory (in units of megabytes, gigabytes or any other appropriate units) that is currently allocated to the virtual machine C 140-3 and the percentage or amount of the memory allocated to the virtual machine C 140-3 that the virtual machine C 140-3 uses in executing the query represented by the execution plan 325 in the virtual machine C 140-3. The current allocated CPU/usage field 615 specifies an amount of a CPU (in units of numbers of CPUs, time slices of CPUs, percentages of CPUs, or any other appropriate units) that is currently allocated to the virtual machine C 140-3 and the percentage or amount of the CPUs allocated to the virtual machine C 140-3 that the virtual machine C 140-3 uses in executing the query represented by the execution plan 325 in the virtual machine C 140-3. The priority 620 specifies the priority or importance of the virtual machine C 140-3 that stores the cost data 360-3, as compared to, or relative to, all other virtual machines. In various embodiments, the priority 620, for all virtual machines, may be scaled, so that, e.g., all priorities are between zero and one, zero and hundred, or within any other appropriate range of values. In various embodiments, the optimizer 315 calculates the cost data 360-3 per a query, per a workload, or per a group of queries, such as all queries sent by the same application or job, or all queries in a batch or set of queries.

The cost data 360-3 further comprises entries, each entry comprising an estimated cost field 625, an estimated (est) cost ratio field 630, a weighted cost ratio field 635, an estimated CPU requested field 640, and an estimated RAM requested field 645.

The estimated cost 625, in an entry, is the cost (e.g., the estimated time), that the optimizer 315 estimates executing the execution plan 325 for the query will take using the current allocated resources (the current allocated memory 610 and the current allocated CPU 615) plus the estimated amount of resources requested (the estimated CPU requested 640 and the estimated RAM requested 645). The optimizer 315 calculates the estimated costs 625 (in the various entries) to execute the query using a variety of amounts (in various entries) of CPU and memory, e.g., a larger amount of CPU and memory than amounts currently allocated to the virtual machine C 140-3, a larger amount of CPU and the same amount of memory as currently allocated to the virtual machine C 140-3, a larger amount of memory and the same amount of CPU as currently allocated to the virtual machine C 140-3, less memory and the same amount of CPU as currently allocated to the virtual machine C 140-3, a smaller amount of CPU and the same amount of memory as currently allocated to the virtual machine C 140-3, and less memory and a smaller amount of CPU as currently allocated to the virtual machine C 140-3. The optimizer 315 calculates the estimated cost ratio 630 of the estimated cost to the current cost, for each estimated cost in each entry by calculating the respective estimated cost 625 divided by the current cost 605.

The optimizer 315 calculates the weighted cost ratio 635, in each entry, to be the priority 620 multiplied by the estimated cost 625, in the same entry, multiplied by the estimated cost ratio 630, in the same entry. Thus, the weighted cost ratio 635=(the priority 620)*(the estimated cost 625)*(the estimated cost 625/the current cost 605), which implies that the weighted cost ratio 635=(the priority 620)*(the estimated cost 625)²/(the current cost 605).

Although FIG. 6 illustrates data regarding the resources of memory and CPU, in other embodiments, resources may comprise bandwidth of the network interface 114 or the network 130, portions or multiples of the storage device 125, or any other resource of the computer 100 capable of being allocated (either exclusively or shared with other virtual machines) to the virtual machine C 140-3.

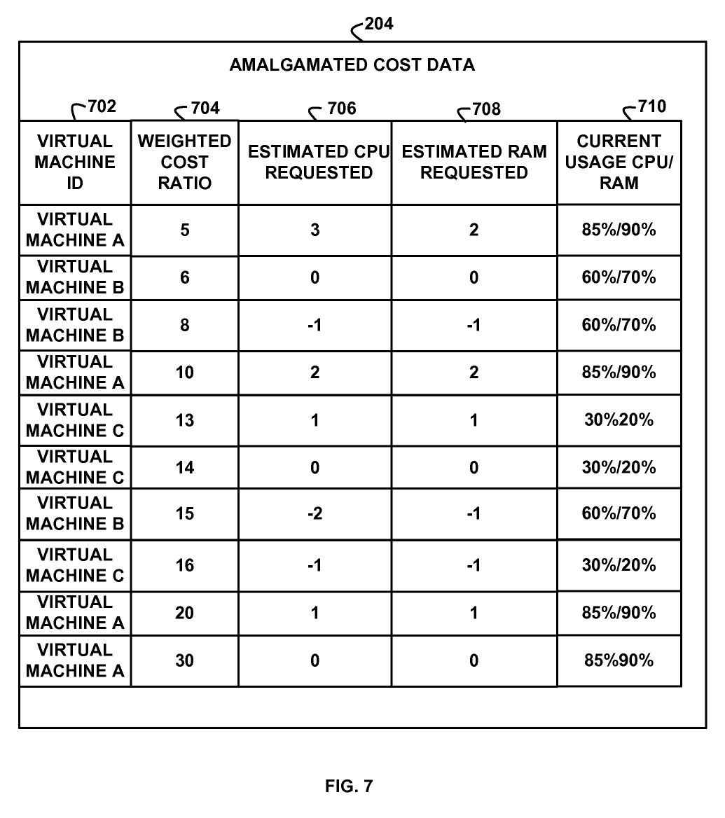

FIG. 7 depicts a block diagram of an example data structure for amalgamated cost data 204 from multiple virtual machines, according to an embodiment of the invention. The amalgamated cost data 204 represents an amalgamation of selected data from the cost data 360-1 of the virtual machine A 140-1, the cost data 360-2 of the virtual machine B 140-2, and the cost data 360-3 of the virtual machine C 140-3. The amalgamated cost data 204 comprises a variety of entries, each of which comprises an example virtual machine identifier field 702, a weighted cost ratio field 704, an estimated CPU requested field 706, an estimated RAM requested field 708, and a current usage 710 for both CPU and RAM.

The cloud resource manager 162 receives cost data from various virtual machines 140 and stores selected elements of the received data into the amalgamated cost data 204. For example, the cloud resource manager 162 stores an identifier 702 of the respective virtual machine 140 that was the source of the respective cost data into the virtual machine identifier field 702. The cloud resource manager 162 further stores the weighted cost ratio 435, 535, and 635 from the entries in the cost data 360-1, 360-2, and 360-3 into the weighted cost ratio field 704 in entries of the amalgamated cost data 204, stores the estimated CPU requested 440, 540, and 640 from the entries in the cost data 360-1, 360-2, and 360-3 into the estimated CPU requested field 706 in entries of the amalgamated cost data 204, stores the estimated RAM requested 445, 545, and 645 from the entries in the cost data 360-1, 360-2, and 360-3 into the estimated RAM requested field 708 in entries of the amalgamated cost data 204, and stores the current usage of the allocated memory and the current usage of the CPU from the fields 410, 415, 510, 515, 610, and 615 from the entries in the cost data 360-1, 360-2, and 360-3 into the current usage CPU/RAM field 710 in entries of the amalgamated cost data 204.

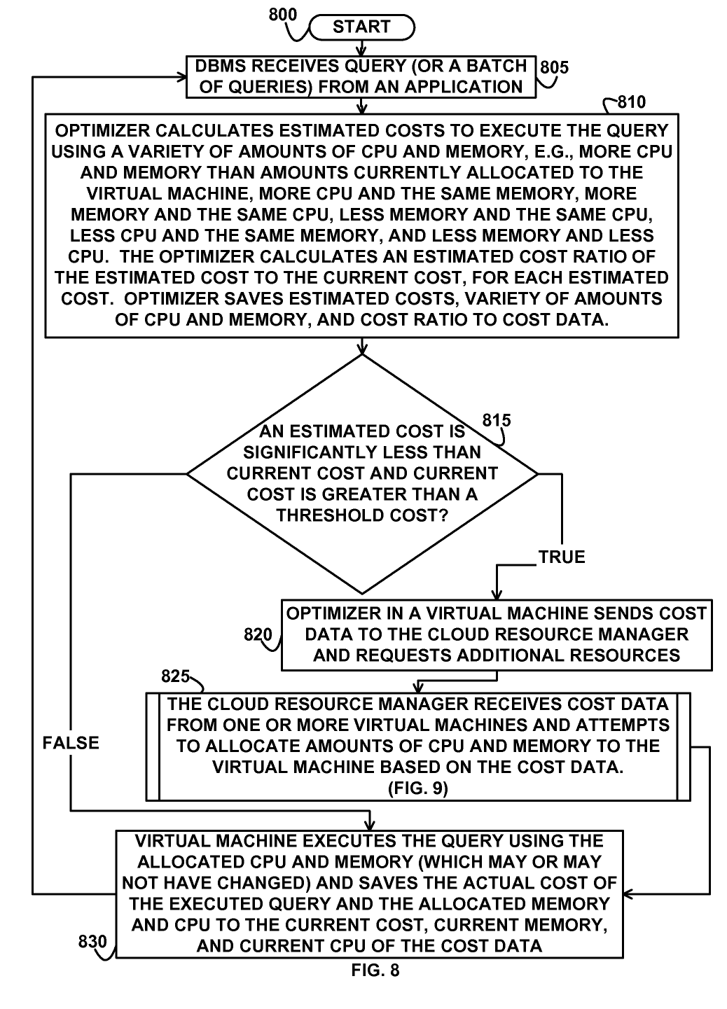

FIG. 8 depicts a flowchart of example processing for a query, according to an embodiment of the invention. The logic of FIG. 8 may be executed by one or more of the virtual machines 140 on the same or different computers simultaneously or concurrently. Control begins at block 800. Control then continues to block 805 where the DBMS 150 receives a query 158 or a batch of queries from an application 160. Control then continues to block 810 where the optimizer 315 calculates estimated costs to execute the received query using a variety of amounts of CPU and memory, e.g., more CPU and memory than amounts currently allocated to the virtual machine 140, more CPU and the same memory as currently allocated to the virtual machine 140, more memory and the same amount of CPU as currently allocated to the virtual machine 140, less memory and the same amount of CPU as currently allocated to the virtual machine 140, less CPU and the same amount of memory as currently allocated to the virtual machine 140, and less memory and less CPU as currently allocated to the virtual machine 140 in which the optimizer 315 executes. The optimizer 315 calculates an estimated cost ratio of the estimated cost to the current cost and the weighted cost ratio, for each estimated cost. The optimizer 315 saves the estimated costs, the weighted cost ratios, the variety of amounts of CPU and memory, and the estimated cost ratios to the cost data for the virtual machine 140 in which the optimizer 315 executes.

In various embodiments, the optimizer 315 keeps increasing or decreasing the amounts of CPU or memory until the estimated costs do not change. For example, if increasing the memory by 1 GB decreases the estimated cost, then the optimizer 315 tries another estimate with even more memory. If that also decreases the estimated cost, then the optimizer 315 continues calculating estimated costs with ever-increasing amounts of memory until increasing the memory further provides no, or a diminishing amount of cost decease.

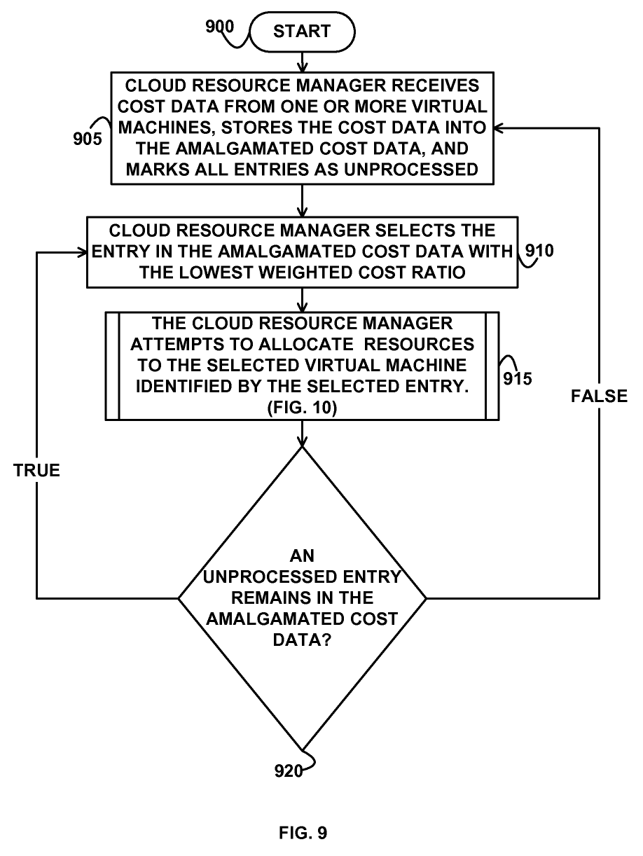

Control then continues to block 815 where the optimizer 315 determines whether any (at least one) of the estimated costs in the cost data is significantly less (more than a current cost threshold less) than the current cost and current cost is greater than a threshold cost. In an embodiment, the use of the threshold cost operates to omit requesting additional resources in situations where the overhead of the reallocation of resources would exceed the performance gain that would result from the reallocation. If the determination at block 815 is true, then at least one of the estimated costs in the cost data is significantly less (more than a current cost threshold less) than the current cost and current cost is greater than a threshold cost, so control continues to block 820 where the optimizer 315 in a virtual machine 140 sends the cost data to the cloud resource manager 162 and requests additional resources to be allocated to the virtual machine 140. Control then continues to block 825 where the cloud resource manager 162 receives the cost data from one or more virtual machines 140 and attempts to allocate amounts of resources (e.g., CPU and memory) to the virtual machines 140 based on the received cost data, as further described below with reference to FIG. 9. Control then continues to block 830 where the virtual machine 140 executes the query using the allocated amounts of resources (e.g., CPU and memory), which may or may not have been changed, and saves the actual cost of the executed query and the allocated memory and CPU to the current cost, current memory, and current CPU of the cost data. Control then returns to block 805 where the DBMS 150 receives the same or a different query from the application, as previously described above.

If the determination at block 815 is false, then none of the estimated costs in the cost data is significantly less (more than a current cost threshold less) than the current cost or the current cost is less than or equal to the threshold cost, so control continues to block 830, as previously described above.

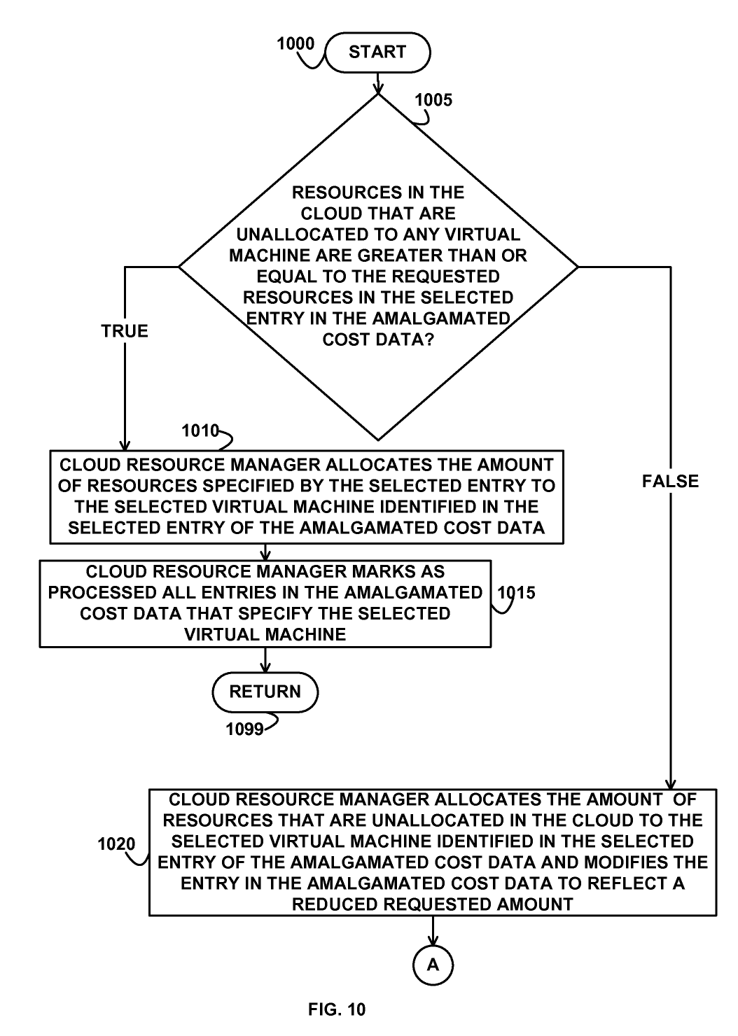

FIG. 9 depicts a flowchart of example processing for a cloud resource manager, according to an embodiment of the invention. Control begins at block 900. Control then continues to block 905 where the cloud resource manager 162 receives cost data 360 from one or more virtual machines 140, stores selected elements of the cost data 360 into the amalgamated cost data 204, and marks all entries in the amalgamated cost data 204 as unprocessed by the logic of FIGS. 9, 10, and 11. Control then continues to block 910 where the cloud resource manager 162 selects the entry in the amalgamated cost data 204 with the lowest weighted cost ratio, as compared to all other weighted cost ratios in all other entries in the amalgamated cost data 204. Control then continues to block 915 where the cloud resource manager 162 attempts to allocate resources to the selected virtual machine 140 identified by the selected entry of the amalgamated cost data 204, as further described below with reference to FIG. 10. Control then continues to block 920 where the cloud resource manager 162 determines whether an entry remains in the amalgamated cost data 204 that has not been processed by the logic of FIGS. 9, 10, and 11.

If the determination at block 920 is true, then an entry remains in the amalgamated cost data 204 that has not been processed by the logic of FIGS. 9, 10, and 11, so control returns to block 910, as previously described above. If the determination at block 920 is false, then all entries in the amalgamated cost data 204 have been processed by the logic of FIGS. 9, 10, and 11, so control returns to block 905 where the cloud resource manager 162 receives the same or different cost data 360 from the same or different virtual machines 140, as previously described above.

FIG. 10 depicts a flowchart of example processing for attempting to allocate resources to a virtual machine, according to an embodiment of the invention. Control begins at block 1000. Control then continues to block 1005 where the cloud resource manager 162 determines whether the amount of resources (e.g., the amount of CPU or memory) in the cloud that are unallocated to any virtual machine 140 is greater than or equal to the amount of the estimated resources requested in the selected entry in the amalgamated cost data 204. If the determination at block 1005 is true, then the amount of resources (e.g., the amount of CPU or memory) in the cloud that is unallocated to any virtual machine 140 is greater than or equal to the amount of the estimated resources requested in the selected entry in the amalgamated cost data 204, so control continues to block 1010 where the cloud resource manager 162 allocates the amount of resources specified by the selected entry to the selected virtual machine 140 identified in the selected entry of the amalgamated cost data 204. In an embodiment, the cloud resource manager 162 exclusively allocates the resources, so that no other virtual machine 140 besides the virtual machine 140 to which the resources or allocated may access or use resources during the time period in which the resources are allocated. Control then continues to block 1015 where the cloud resource manager 162 marks as processed all entries in the amalgamated cost data 204 that specify the selected virtual machine 140. Control then continues to block 1099 where the logic of FIG. 10 returns.

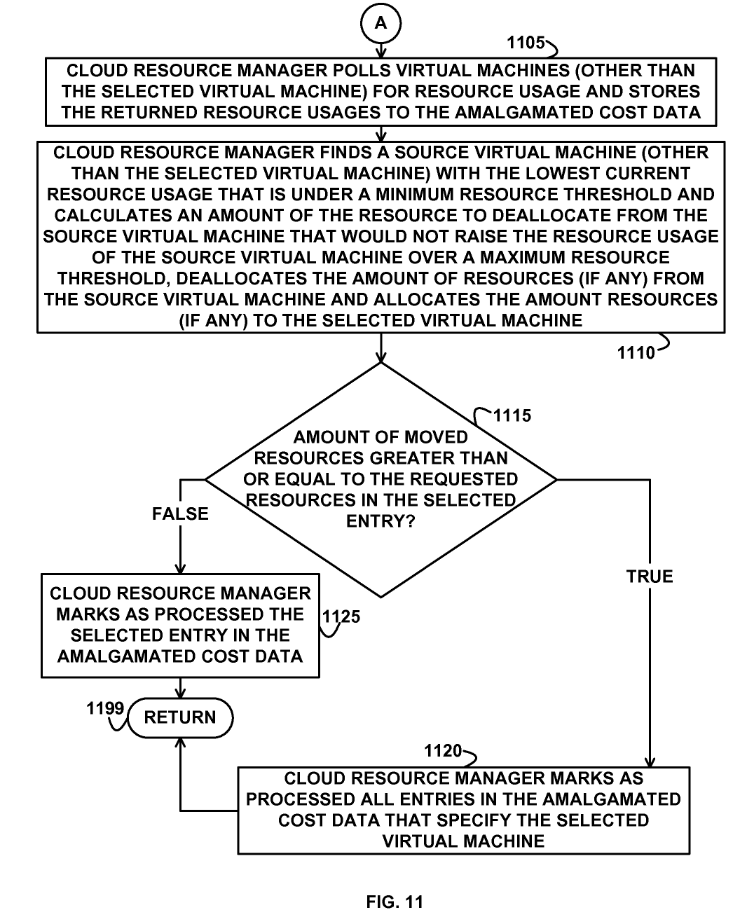

If the determination at block 1005 is false, then the amount of resources (e.g., the amount of CPU or memory) in the cloud that is unallocated to any virtual machine 140 is less than the amount of the estimated resources requested in the selected entry in the amalgamated cost data 204, so control continues to block 1020 where the cloud resource manager 162 allocates the amount of resources that are unallocated in the cloud to the selected virtual machine 140 identified in the selected entry of the amalgamated cost data 204 and modifies the entry in the amalgamated cost data 204 to reflect a requested amount reduced by the amount of resources allocated. Control then continues to block 1105 of FIG. 11 where the cloud resource manager 162 polls virtual machines 140 (other than the selected virtual machine) for resource usage and stores the returned resource usages to the amalgamated cost data 204.

Control then continues to block 1110 where the cloud resource manager 162 finds a source virtual machine (other than the selected virtual machine) with the lowest current resource usage percentage that is under a minimum resource threshold and calculates an amount of the resource to deallocate from the source virtual machine that does not raise (is estimated to not raise) the current resource usage percentage of the source virtual machine over a maximum resource threshold, deallocates the amount of resources (if any) from the source virtual machine, and reallocates the amount of resources (if any) to the selected virtual machine.

In an embodiment, the cloud resource manager 162 estimates whether deallocating the resource from the source virtual machine raises the resource usage of the source virtual machine over a maximum resource threshold by calculating a ratio and comparing the ratio to the maximum resource threshold. For example, if the current CPU allocation to a virtual machine 140 is 2 CPUs, the current CPU usage of the virtual machine 140 is 50% usage, and 1 CPU is estimated to be deallocated from the virtual machine 140, so that 1 CPU remains allocated to the virtual machine 140, then the estimated CPU usage of the virtual machine 140 changes to 100% utilization, which may be calculated via the following analysis: 0.5 (2 CPUs)=(estimated usage)*1 CPU, which implies that: estimated usage=1, so that 100% of 1 CPU is the estimated CPU usage after 1 CPU is deallocated. Similarly, if 3 GB of memory is 40% utilized by a virtual machine 140, and the cloud resource manager 162 is estimated to allocate 3 GB of memory to the virtual machine 140, then 0.4 (3 GB)=(estimated usage)*6 GB, which implies that the estimated usage=0.2, so the 6 GB is estimated to be 20% utilized with an allocation of 6 GB. Thus, the cloud resource manager 162 multiples the current resource usage percentage of the source virtual machine by the amount of current resources allocated to the source virtual machine and divides the result of the multiplication by the amount of estimated resources present after prospective deallocation from the source virtual machine 140 to create a resultant estimated usage for the source virtual machine. The cloud resource manager 162 then compares the resultant estimated usage to the maximum resource threshold. If the resultant estimated usage is greater than the maximum resource threshold, then the virtual machine, then the cloud resource manager 162 does not deallocate the estimated resource amount from the source virtual machine. Instead, the cloud resource manager recomputes the estimated usage from a different deallocation amount. If the resultant estimated usage is less than or equal to the maximum resource threshold, then the cloud resource manager deallocates the estimated amount from the source virtual machine.

Control then continues to block 1115 where the cloud resource manager 162 determines whether the amount of moved resources is greater than or equal to the amount of requested resources in the selected entry. If the determination at block 1115 is true, then the amount of moved resources is greater than or equal to the requested resources in the selected entry, so control continues to block 1120 where the cloud resource manager 162 marks as processed all entries in the amalgamated cost data 204 that specify the selected virtual machine 140. Control then continues to block 1199 where the logic of FIGS. 10 and 11 returns.

If the determination at block 1115 is false, then the amount of moved resources is less than the amount of estimated requested resources in the selected entry, so control continues to block 1125 where the cloud resource manager 162 marks as processed the selected entry in the amalgamated cost data 204. Control then continues to block 1199 where the logic of FIGS. 10 and 11 returns.

In this way, in an embodiment, the DBMS 150 may optimize use of resources in the cloud based not only on past performance or past resource usage but also based on estimates of future resource use, in order to better use cloud resources and allow queries to execute faster and more efficiently.

The logic represented by FIGS. 8, 9, 10, and 11 may be reentrant and may be executed concurrently, substantially concurrently, or interleaved by multiple threads on the same or different processors on the same or different computers, creating and executing the same or different execution plans via multi-threading, multi-tasking, multi-programming, or multi-processing techniques.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
receiving a plurality of estimates of costs of executing a plurality of respective queries from a plurality of respective virtual machines using a plurality of respective estimated resources allocated to the plurality of respective virtual machines;
selecting a selected virtual machine of the plurality of respective virtual machines with a lowest weighted cost ratio as compared to all other of the plurality of respective virtual machines;
finding a source virtual machine from among the plurality of respective virtual machines with a lowest current resource usage percentage;
calculating an amount of a resource to deallocate from the source virtual machine, wherein the calculating further comprises estimating the amount of the resource to deallocate that does not raise the lowest current resource usage percentage of the source virtual machine over a maximum resource threshold;
deallocating the amount of the resource from the source virtual machine; and
allocating the amount of the resource to the selected virtual machine.

2. The method of claim 1, further comprising:
executing one of the plurality of respective queries at the selected virtual machine using the amount of the resource allocated by the allocating.

3. The method of claim 1, wherein the selecting the selected virtual machine of the plurality of respective virtual machines with the lowest weighted cost ratio as compared to all other of the plurality of respective virtual machines further comprises:
calculating a plurality of weighted cost ratios for the plurality of respective virtual machines, wherein the calculating the plurality of weighted cost ratios for the plurality of respective virtual machines further comprises multiplying a priority of the respective virtual machine by an estimated cost squared of an estimated amount of a resource divided by a current cost of a current amount of the resource allocated to the virtual machine.

4. The method of claim 1, wherein the estimating the amount of the resource to deallocate from the source virtual machine that does not raise the lowest current resource usage percentage of the source virtual machine over a maximum resource threshold further comprises:
multiplying the lowest current resource usage percentage of the source virtual machine by an amount of current resources allocated to the source virtual machine; and
dividing a result of the multiplying by an amount of estimated resources present after prospective deallocation from the source virtual machine to create a resultant estimated usage.

5. The method of claim 4, further comprising:
comparing the resultant estimated usage to the maximum resource threshold; and
if the resultant estimated usage is greater than the maximum resource threshold, refraining from deallocating the amount of the resource from the source virtual machine.

6. The method of claim 5, further comprising:
if the resultant estimated usage is greater than the maximum resource threshold, recomputing the resultant estimated usage from a different amount of estimated resources present.

7. The method of claim 6 further comprising:
if the resultant estimated usage is less than or equal to the maximum resource threshold, deallocating the amount of the resource from the source virtual machine.

8. The method of claim 1, wherein the plurality of respective queries comprise a workload.

9. A computer-readable medium encoded with instructions, wherein the instructions when executed comprise:
receiving a plurality of estimates of costs of executing a plurality of respective queries from a plurality of respective virtual machines using a plurality of respective estimated resources allocated to the plurality of respective virtual machines;
selecting a selected virtual machine of the plurality of respective virtual machines with a lowest weighted cost ratio as compared to all other of the plurality of respective virtual machines;
finding a source virtual machine from among the plurality of respective virtual machines with a lowest current resource usage percentage;
calculating an amount of a resource to deallocate from the source virtual machine, wherein the calculating further comprises estimating the amount of the resource to deallocate that does not raise the lowest current resource usage percentage of the source virtual machine over a maximum resource threshold;
deallocating the amount of the resource from the source virtual machine;
allocating the amount of the resource to the selected virtual machine; and
executing one of the plurality of respective queries at the selected virtual machine using the amount of the resource allocated by the allocating.

10. The computer-readable medium of claim 9, wherein the selecting the selected virtual machine of the plurality of respective virtual machines with the lowest weighted cost ratio as compared to all other of the plurality of respective virtual machines further comprises:
calculating a plurality of weighted cost ratios for the plurality of respective virtual machines, wherein the calculating the plurality of weighted cost ratios for the plurality of respective virtual machines further comprises multiplying a priority of the respective virtual machine by an estimated cost squared of an estimated amount of a resource divided by a current cost of a current amount of the resource allocated to the virtual machine.

11. The computer-readable medium of claim 9, wherein the estimating the amount of the resource to deallocate from the source virtual machine that does not raise the lowest current resource usage percentage of the source virtual machine over a maximum resource threshold further comprises:
multiplying the lowest current resource usage percentage of the source virtual machine by an amount of current resources allocated to the source virtual machine; and
dividing a result of the multiplying by an amount of estimated resources present after prospective deallocation from the source virtual machine to create a resultant estimated usage.

12. The computer-readable medium of claim 11, further comprising:
comparing the resultant estimated usage to the maximum resource threshold; and
if the resultant estimated usage is greater than the maximum resource threshold, refraining from deallocating the amount of the resource from the source virtual machine.

13. The computer-readable medium of claim 12, further comprising:
if the resultant estimated usage is greater than the maximum resource threshold, recomputing the resultant estimated usage from a different amount of estimated resources present.

14. The computer-readable medium of claim 13 further comprising:
if the resultant estimated usage is less than or equal to the maximum resource threshold, deallocating the amount of the resource from the source virtual machine.

15. A computer system comprising:
a processor; and
memory communicatively connected to the processor, wherein the memory is encoded with instructions, and wherein the instructions when executed by the processor comprise
receiving a plurality of estimates of costs of executing a plurality of respective queries from a plurality of respective virtual machines using a plurality of respective estimated resources allocated to the plurality of respective virtual machines,
selecting a selected virtual machine of the plurality of respective virtual machines with a lowest weighted cost ratio as compared to all other of the plurality of respective virtual machines,
finding a source virtual machine from among the plurality of respective virtual machines with a lowest current resource usage percentage,
calculating an amount of a resource to deallocate from the source virtual machine, wherein the calculating further comprises estimating the amount of the resource to deallocate that does not raise the lowest current resource usage percentage of the source virtual machine over a maximum resource threshold,
deallocating the amount of the resource from the source virtual machine,
allocating the amount of the resource to the selected virtual machine, and
executing one of the plurality of respective queries at the selected virtual machine using the amount of the resource allocated by the allocating.

16. The computer system of claim 15, wherein the selecting the selected virtual machine of the plurality of respective virtual machines with the lowest weighted cost ratio as compared to all other of the plurality of respective virtual machines further comprises:
calculating a plurality of weighted cost ratios for the plurality of respective virtual machines, wherein the calculating the plurality of weighted cost ratios for the plurality of respective virtual machines further comprises multiplying a priority of the respective virtual machine by an estimated cost squared of an estimated amount of a resource divided by a current cost of a current amount of the resource allocated to the virtual machine.

17. The computer system of claim 15, wherein the estimating the amount of the resource to deallocate from the source virtual machine that does not raise the lowest current resource usage percentage of the source virtual machine over a maximum resource threshold further comprises:
multiplying the lowest current resource usage percentage of the source virtual machine by an amount of current resources allocated to the source virtual machine; and
dividing a result of the multiplying by an amount of estimated resources present after prospective deallocation from the source virtual machine to create a resultant estimated usage.

18. The computer system of claim 17, wherein the instructions further comprise:
comparing the resultant estimated usage to the maximum resource threshold; and
if the resultant estimated usage is greater than the maximum resource threshold, refraining from deallocating the amount of the resource from the source virtual machine.

19. The computer system of claim 18, wherein the instructions further comprise:
if the resultant estimated usage is greater than the maximum resource threshold, recomputing the resultant estimated usage from a different amount of estimated resources present.

20. The computer system of claim 19, wherein the instructions further comprise:
if the resultant estimated usage is less than or equal to the maximum resource threshold, deallocating the amount of the resource from the source virtual machine.
